(19) United States
(12) Patent Application Publication
(10) Pub. No.: US 2026/0213838 A1
(43) Pub. Date: Jul. 23, 2026

(54) METHOD AND SYSTEM FOR TESTING A FIBRE OPTIC NETWORK

(71) Applicant: BRITISH TELECOMMUNICATIONS PUBLIC LIMITED COMPANY, London, Greater London (GB)

(72) Inventor: Ian HORSLEY, London (GB)

(21) Appl. No.: 19/152,299

(22) PCT Filed: Dec. 13, 2023
(86) PCT No.: PCT/EP2023/085615

§ 371 Date: Jul. 30, 2025

(30) Foreign Application Priority Data
Jan. 31, 2023 (EP) 23154188.9

(51) Int. Cl. H04B 10/071; G01M 11/00

(52) U.S. Cl. CPC H04B 10/071; G01M 11/3136

(57) ABSTRACT

Method and System for Testing a Fibre Optic Network A method (500) of testing a fibre optic network (100) so as to locate a feature of said network using a Mechanically Induced Filter (200), MIF, comprising a grating (210), the method comprising the steps of: retrieving, from an optical reflectometry measuring device (120), a: first test result (600-1), from a first optical reflectometry test performed through a fibre optic cable (170-1) of the fibre optic network, said first test result comprising a reflection result (610) indicative of a feature within the fibre optic network (510); second test result (600-2), from a second optical reflectometry test performed whilst using a MIF to force the grating upon the fibre optic cable, at a selected location, so as to cause a filtering effect upon the second test result (520); comparing the first test result and the second test result so as to identify whether the reflection result is affected in the second test result by the filtering effect (530); and determining, along the fibre optic cable, a location range for the feature, in which said location range is determined to be: away from both the optical reflectometry measuring device and the selected location, in response to identifying that the reflection result is affected by the filtering effect (540); and between the optical reflectometry measuring device and the selected location, in response to identifying that the reflection result is not affected by the filtering effect (550).

### FIELD OF INVENTION

The present invention relates to method of testing a fibre optic network, and in particular by using a Mechanically Induced Filter to affect transmissivity through the fibre optic network.

### BACKGROUND

Large-scale fibre optic networks, as used in wide-area fixed-access telecommunications, are complex, and the infrastructure required to establish such networks may be difficult to access. As a result, such networks can be difficult to monitor and audit. In turn, identifying and locating specific network features (e.g. fibre optic cables, connectors, splitters, switches, filters and other components, as well as faults and rogue elements) may be a considerable challenge.

An Optical Time Domain Reflectometer (OTDR) is a diagnostic device, used in fibre optic networks, that injects an optical pulse (or a “diagnostic signal”) and measures the arrival time of (and, by inference, a distance travelled by) light reflected as a result of Fresnel back-reflections and Rayleigh backscatter from fibre optic cables and reflections from connectors, components and other discontinuities in the network. A resultant OTDR trace is produced in which features, and their state, can be identified from characteristics of detected reflections.

However, interpreting an OTDR trace presents challenges, and such traces can have limited real-world efficacy. Typically, an OTDR trace is manually interpreted by trained engineers who tag identified features. However, an OTDR trace may contain a large number of reflections (often, at least thirty), and manual analysis can therefore be time-consuming. Furthermore, co-located features (especially downstream of splitters in a Passive Optical Network) may not be distinguishable in OTDR traces, and therefore cannot be individually discerned for identification. Yet further, physically locating a sought network feature using distances calculated from an OTDR trace may also be difficult, since fibre optic cables may have slack and small deviations, and also because the accuracy of calculating distances requires accurate knowledge of refractive indices, which may unknowingly vary with temperature and media. As a result, interpreting OTDR traces can be labour- and resource-intensive, and may also be error-prone or lead to conclusions that do not correspond with the actual physical network.

Similarly, an Optical Line Terminal (OLT), used to transmit and receive service signals, can also be used to detect the operating status of transmitting components of the fibre optic network, and in particular to detect the presence of a rogue transmitting component. However, OLTs, and the architecture of large-scale fibre optic networks, are not suitable for identifying and pinpointing a specific transmitting component.

It is an aim of the present invention to at least alleviate some of the aforementioned problems.

### STATEMENTS OF INVENTION

According to a first aspect of the present invention, there is provided: a method of testing a fibre optic network so as to locate a feature of said network using a Mechanically Induced Filter, MIF, comprising a grating, the method comprising the steps of: retrieving, from an optical reflectometry measuring device, a: first test result, from a first optical reflectometry test performed through a fibre optic cable of the fibre optic network, said first test result comprising a reflection result indicative of a feature within the fibre optic network; second test result, from a second optical reflectometry test performed whilst using a MIF to force the grating upon the fibre optic cable, at a selected location, so as to cause a filtering effect upon the second test result (optionally, compared to the first test result); comparing the first test result and the second test result so as to identify whether the reflection result is affected in the second test result by the filtering effect; and determining, along the fibre optic cable, a location range for the feature, in which said location range is determined to be: away from both (optionally, not in between and/or downstream of) the optical reflectometry measuring device and the selected location, in response to identifying that the reflection result is affected by the filtering effect; and between the optical reflectometry measuring device and the selected location, in response to identifying that the reflection result is not affected by the filtering effect.

Optionally, the feature is a: fault, impairment or break; location; component, joint, connector or splice; and/or a specific reflection. Optionally, the feature is a/an: faulty or dislodged fibre joint, connection or splice; fibre fracture or break; and/or faulty, improperly installed or configured, and/or malfunctioning equipment or fibre bend. Optionally, the reflective result is indicative of the feature by a substantial local, relative and characteristic increased or decreased reflection. Optionally, the location range is a relative location. Preferably, the filtering effect causes an upstream shift of a commencement of noise floor in the second optical reflectometry test result compared to the first optical reflectometry test result. Optionally, where no such upstream shift is identified, determining that the MIF is: incorrectly applied to the fibre optic cable; applied to a different fibre optic cable to that which the first optical reflectometry test is performed; and/or applied at a location beyond a detection range of the optical reflectometry measuring device, and in response taking corrective action, including reapplying the, or another, MIF to the or another fibre optic cable at the or another location, which may be closer to the optical reflectometry measuring device. Preferably, the first and the second optical reflectometry tests may be performed in any relative sequence, as may the associated retrieval of the corresponding results. Preferably, the first and the second optical reflectometry test are performed using light transmissions having the same or different wavelengths. Optionally, at least, the step/s of retrieving and/or comparing the first and the second optical reflectometry test results is/are computer-implemented. Preferably, the selected location of the MIF is mapped, on the first and/or second test result/s, as the position at which the filtering effect occurs. Preferably, the method further comprises the step of estimating the relative distance between the feature from a separation between the feature and the commencement of the filtering effect in second test result. Optionally, the step/s of retrieving, comparing and/or determining is/are performed by the optical reflectometry measuring device and/or by a processor (in any combination), remote from the optical reflectometry measuring device. Preferably, forcing the MIF upon the fibre optic cable causes an increased filtering effect compared to not forcing the MIF upon the fibre optic cable. Preferably, the filtering effect causes an attenuation in the reflection result. Optionally, the reflection result is caused by backscatter, and more preferably by Rayleigh backscatter.

Preferably, the method further comprises the step of: applying the, or another, MIF at a subsequently selected location, wherein said subsequently selected location is within the location range; retrieving, from the optical reflectometry measuring device, a third test result, from a third optical reflectometry test performed whilst using said MIF to force the grating upon the fibre optic cable, at the subsequently selected location, so as to result in the filtering effect upon the third optical reflectometry test; comparing the first test result, or the second test result, and the third test result so as to identify whether the reflection result is affected in the second test result by the filtering effect; and determining a further location range for the feature, in which said further location range is determined to be: away from both (optionally, not in between downstream of) the optical reflectometry measuring device and the subsequently selected location, in response to identifying that the reflection result is affected in the second test result by the filtering effect; and between the optical reflectometry measuring device and the subsequently selected location, in response to identifying that the reflection result is not affected by the filtering effect. Preferably, the subsequently selected location is different to the selected location. Optionally, the selected and/or subsequently selected location/s is/are an estimated location of the feature in which said estimated location is derived from the position of the reflection result in the first test result. Preferably, the grating is tuned (at least by selection of the appropriate periodicity of the grating), relative to a wavelength of a light transmission of the second and/or third optical reflectometry test, to cause the filtering effect. Preferably, the first, second and/or third optical reflectometry test/s consist of a downstream transmission that is; from a headend towards an end-user terminal.

Preferably, the first test is also performed whilst compressing the grating upon the fibre optic cable, and is performed so as to cause a lesser filtering effect upon the first optical reflectometry test compared to the filtering effect upon the second and/or third optical reflectometry test/s. Preferably, the lesser filtering effect is achieved by performing the first optical reflectometry test and the second and/or third optical reflectometry test/s using different wavelengths, wherein the MIF is configured to result in each of the filtering effects at said corresponding different wavelengths. Preferably, wherein the lesser filtering effect is achieved by performing the first optical reflectometry test using a different (first) wavelength to a (second) wavelength used for the second optical reflectometry test, wherein the MIF is configured to cause the lesser filtering effect at said (first) different wavelength, but not at the (second) wavelength. Preferably, the lesser filtering effect is achieved by performing the first optical reflectometry test whilst using a lower (optionally, lesser) force at which the grating is forced upon the fibre optic cable compared to that at which the grating is forced upon the fibre optic cable whilst performing the second and/or third optical reflectometry test/s. Optionally, the different forces are non-zero. Preferably, the lesser filtering effect is achieved by performing the first optical reflectometry test and the second and/or third optical reflectometry test/s whilst forcing the grating at different angles relative to (a point, or optionally axis, of contact with) the fibre optic cable, and wherein the MIF is configured to result in each of the filtering effects at said corresponding different angles, which may be achieved by changing a periodicity of the grating with said different angles.

Preferably, the first test is performed without compressing the grating upon the fibre optic cable. In this way, the reflection result, and the first diagnostics optical reflectometry test may be unaffected by the MIF. Preferably, the MIF is configured to induce a Long-Period Fiber Grating, LPFG, or a Fibre Bragg Grating, FGB, more generally, when compressing the grating upon the fibre optic cable. Preferably, the reflection result is affected in the second test result by the filtering effect in that said reflection result is reduced (partially or wholly) in the second test result compared to the first test result.

Preferably, the grating is directly urged upon a jacket or a cladding of the fibre optic cable. Preferably, the outer jacket of the fibre is removed so as to permit direct compression of the cladding. Preferably, the MIF directly compresses the fibre optic cable proximate a joint, aggregation node or splitter node. Preferably, the MIF remains outside of a path of light transmissions through the fibre optic cable; that is, the MIF is not an in-line filter. Preferably, the MIF remains optically uncoupled from the fibre optic cable, and may be entirely separate and separable from the fibre optic cable.

Preferably, the optical reflectometry measuring device is an Optical Time-Domain Reflectometer, OTDR, and/or an Optical Line Terminal for transmitting and receiving a telecommunications service signal through the fibre optic network. Preferably, the optical reflectometry measuring device is configured to perform the first, second and/or third optical reflectometry test/s. Preferably, the optical reflectometry measuring device comprises an optical source (more preferably a laser) and a light detector. Optionally, the optical source is a telecommunications service, and/or testing and diagnostics, signal generator and transmitter.

Preferably, the first and/or second optical reflectometry test/s is/are performed using a service signal and/or a diagnostic test signal. Optionally, the third optical reflectometry test is performed using a service signal and/or a diagnostic test signal. Preferably, the service signal is used to communicate a telecommunications service to a user. Preferably, the service signal operates at a service wavelength, and wherein the service wavelength is more than 1200 nm. Preferably, the diagnostic test signal (or pulse) does not carry signals for providing a telecommunications service to a user, and is therefore merely for testing and diagnostics, and is operated at a diagnostic test wavelength. Preferably, the diagnostic test wavelength is within the U-band or C-band, as defined by the ITU Telecommunication Standardization Sector. Preferably, the diagnostic test wavelength is between 1200 nm and 1700 nm, and still more preferably between 1625 nm and 1675 nm, or between 1535 nm and 1565 nm. Optionally, the service signal is an upstream service signal from a rogue component of the fibre optic network, and may have a wavelength of between 1300 nm and 1550 nm.

Preferably, the MIF is remotely operated (optionally, by means of robotics and/or actuators) so as to be urged against the fibre optic cable, thereby to cause the first and/or second extents of filtering. Optionally, using the MIF so as to cause the first and/or second extents of filtering subsequently triggers the first and/or second test/s, respectively.

According to another aspect of the invention, there is provided a computer-readable carrier medium comprising a computer program, which, when the computer program is executed by a computer, causes the computer to carry out the any of the methods described above.

According to another aspect of the invention, there is provided a system for testing a fibre optic network so as to locate a feature of said network, said system comprising a: Mechanically Induced Filter, MIF, comprising a grating configured to be forced upon the fibre optic cable; and processor configured to: retrieve (or receive), from an optical reflectometry measuring device, a: first test result, from a first optical reflectometry test performed through a fibre optic cable of the fibre optic network, said first test result comprising a reflection result indicative of a feature within the fibre optic network; second test result, from a second optical reflectometry test performed whilst using a MIF to force the grating upon the fibre optic cable, at a selected location, so as to cause a filtering effect upon the second test result (optionally, compared to the first test result); compare the first test result and the second test result so as to identify whether the reflection result is affected in the second test result by the filtering effect; and determine, along the fibre optic cable, a location range for the feature, in which said location range is determined to be: away from both (optionally, not in between downstream of) the optical reflectometry measuring device and the selected location, in response to identifying that the reflection result is affected by the filtering effect; and between the optical reflectometry measuring device and the selected location, in response to identifying that the reflection result is not affected by the filtering effect. Optionally, the optical reflectometry measuring device forms a part of the system.

Preferably, the MIF comprises a first plate and an opposing second plate, wherein the first or second plate is flat. Optionally, the first plate and the second plate are rotatable relative to one another. Preferably, the first plate and second plate are dimensioned so as to receive and clamp the cladding and/or outer jacket of the fibre optic cable. Optionally, the second plate comprises a grating. Optionally, said grating is identical to the grating of the first plate. Optionally, said grating is arranged to intermesh with the grating of the first plate or are otherwise aligned with one another. Preferably, the grating is a notched grating. Optionally, the MIF is in the form of a hand tool comprising pivoted arms, the grating being arranged on one such arm, and an opposing abutment plate being provided on another of the arms, wherein the MIF is pivoted so as to compress the fibre cable between the grating and the opposing abutment plate. Optionally, the MIF comprises a spring tensioner for the arms. Optionally, the grating and the abutment plate are flat. Optionally, the grating is removable, and may be interchangeable. Optionally, the MIF comprises a clamp for urging the arms together. Preferably, the filtering effect of the MIF is controllable, known, reversible, non-destructive, and/or repeatable. Preferably, the fibre optic network is a point-to-multipoint network and/or a Passive Optical Network. Preferably, the fibre optic cable is a single core fibre optic cable.

The invention includes any novel aspects described and/or illustrated herein. The invention also extends to methods and/or apparatus substantially as herein described and/or as illustrated with reference to the accompanying drawings. The invention is also provided as a computer program and/or a computer program product for carrying out any of the methods described herein and/or for embodying any of the apparatus features described herein, and a computer-readable medium storing thereon a program for carrying out any of the methods and/or for embodying any of the apparatus features described herein. Features described as being implemented in hardware may alternatively be implemented in software, and vice versa.

Any apparatus feature may also be provided as a corresponding step of a method, and vice versa. As used herein, means plus function features may alternatively be expressed in terms of their corresponding structure, for example as a suitably-programmed processor.

Any feature in one aspect of the invention may be applied, in any appropriate combination, to other aspects of the invention. Any, some and/or all features in one aspect can be applied to any, some and/or all features in any other aspect, in any appropriate combination. Particular combinations of the various features described and defined in any aspects of the invention can be implemented and/or supplied and/or used independently.

As used throughout, the word ‘or’ can be interpreted in the exclusive and/or inclusive sense, unless otherwise specified.

The invention extends to a method and system as described herein and/or substantially as illustrated with reference to the accompanying drawings. The present invention is now described, purely by way of example, with reference to the accompanying diagrammatic drawings, in which:

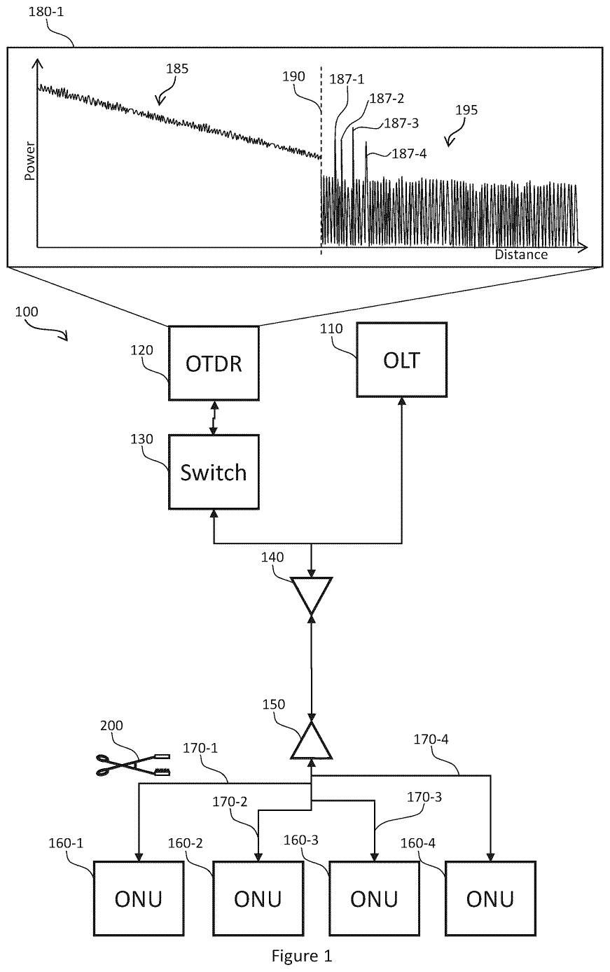

FIG. 1 shows an exemplary fibre optic telecommunications network alongside a Mechanically-Induced Filter (MIF);

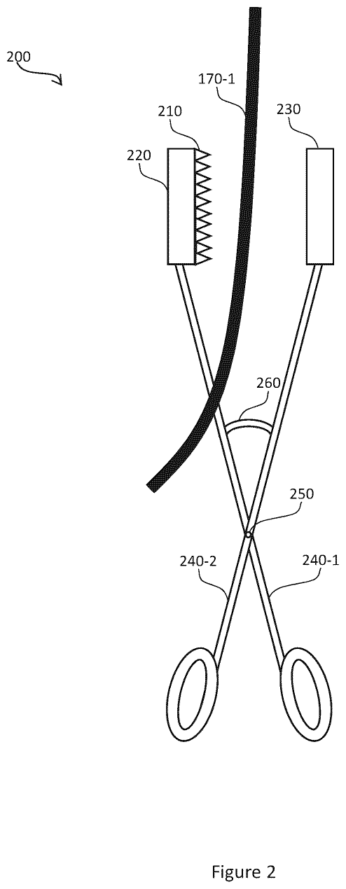

FIG. 2 shows the MIF in detail;

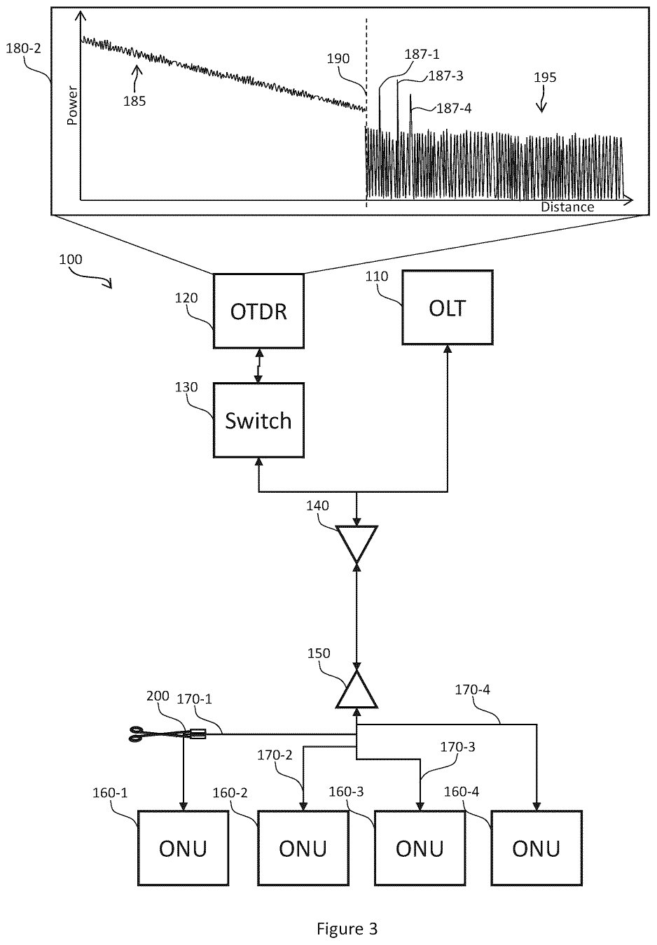

FIG. 3 shows the fibre optic telecommunications network with the Mechanically-Induced Filter (MIF) in use;

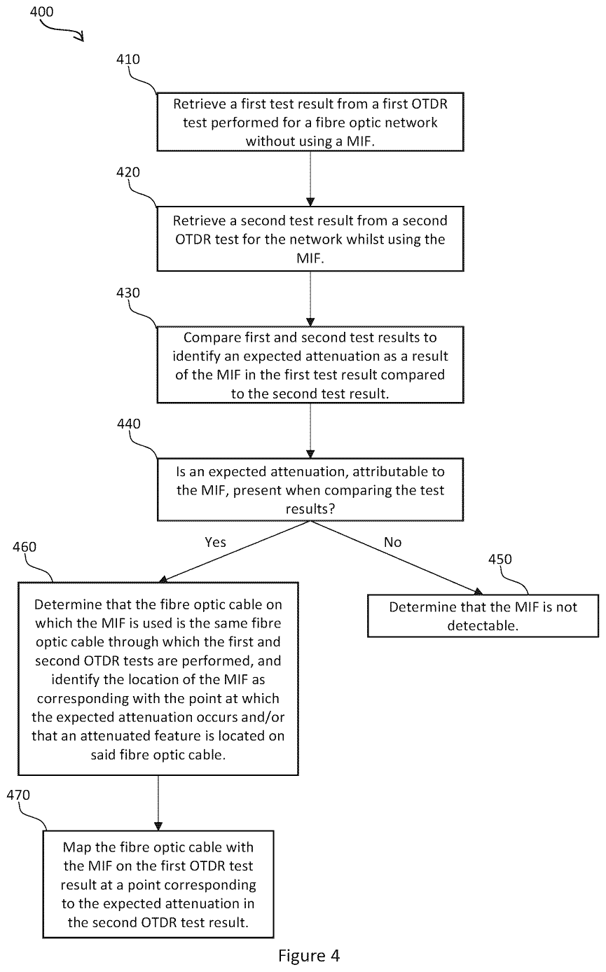

FIG. 4 is a process for using the MIF to identify a fibre optic cable of the fibre optic telecommunications network;

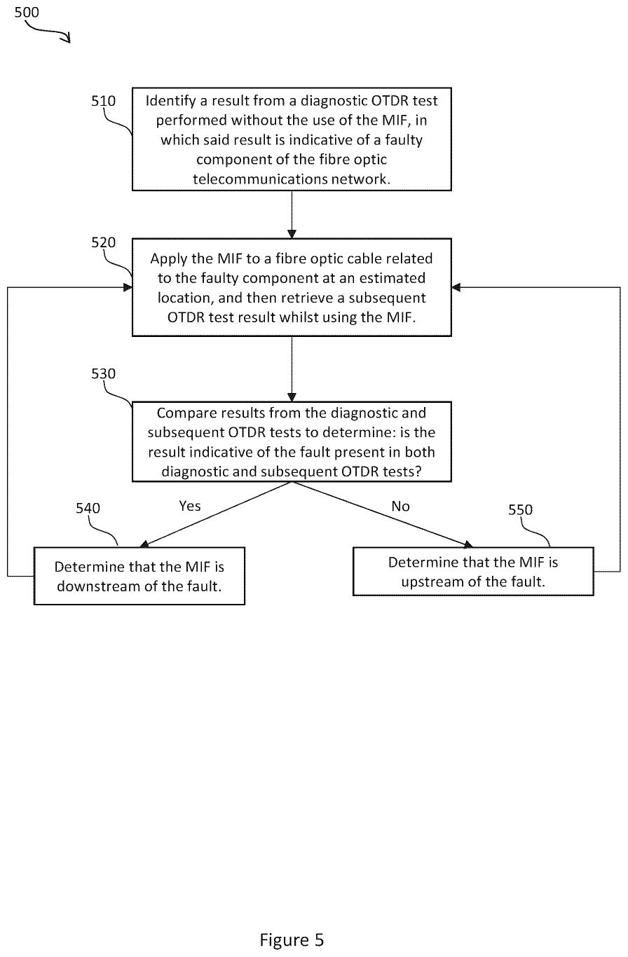

FIG. 5 is a process for using the MIF to locate a fault in the fibre optic telecommunications network;

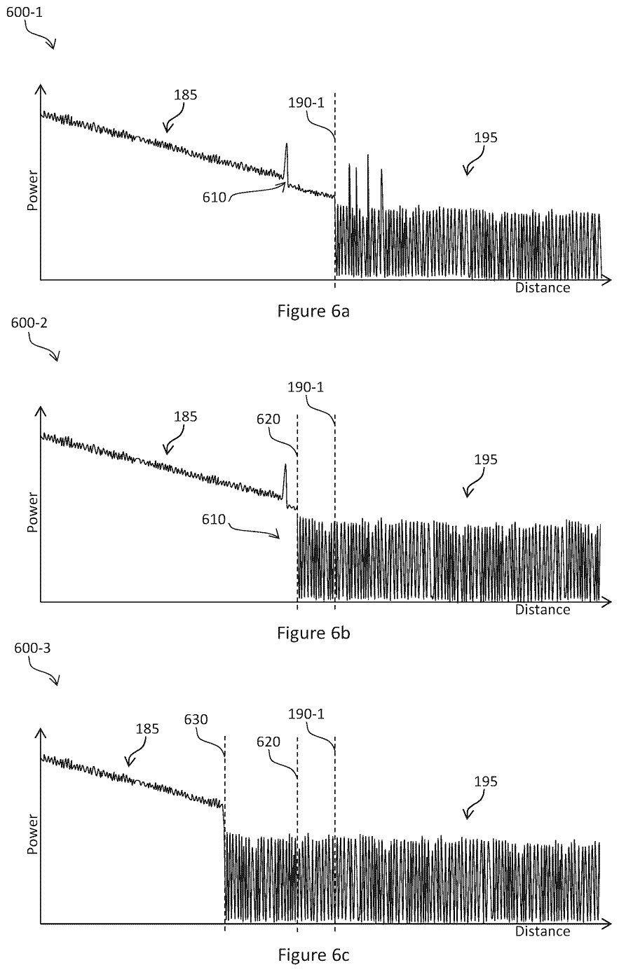

FIGS. 6a, 6b and 6c show schematic diagnostic test results for diagnostic tests performed as part of the aforementioned process for using the MIF to locate a fault; and

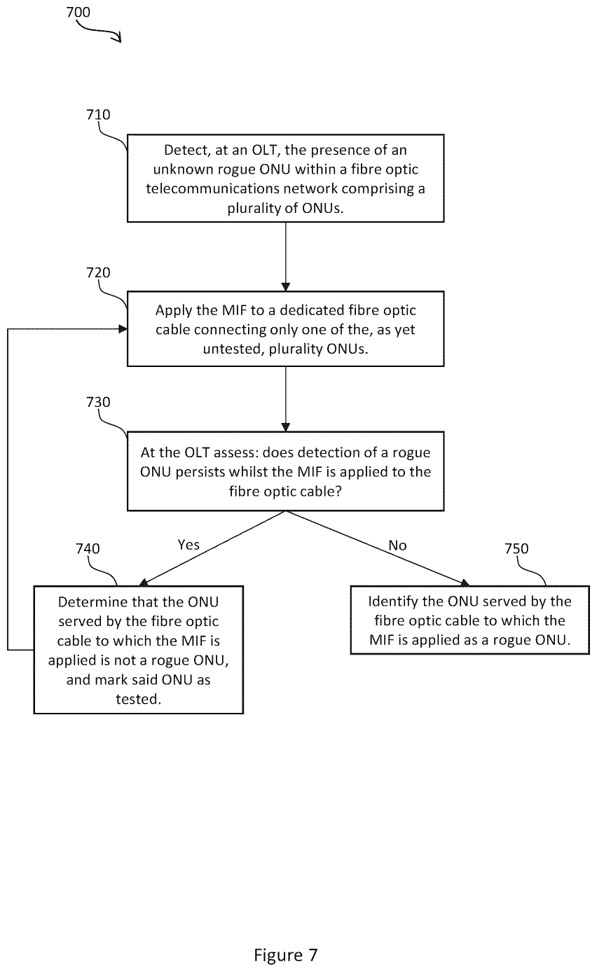

FIG. 7 is a process for using the MIF to identify a rogue component in the fibre optic telecommunications network.

### SPECIFIC DESCRIPTION

FIG. 1 is a schematic diagram of a fibre optic telecommunications network 100, such as for providing wide-area fixed-access broadband network services.

The network 100 comprises a/an: Optical Line Terminal (OLT) 110; Optical Time Domain Reflectometer (OTDR) 120; switch 130; WDM splitter 140; power splitter 150; and a plurality of Optical Network Units (ONUs) 160, including a first 160-1, second 160-2, third 160-3 and fourth 160-4 ONU. The aforementioned components are interconnected using optical links provided using, at least, fibre optic cables (represented as arrowed lines) so as to provide telecommunications services between, at least, the OLT 110 and each of the ONUs 160, and diagnostic test services between, at least, the OTDR 120 and the same ONUs 160.

The OLT 110 is located at the head-end of the network 100, for example where a local exchange is sited, and is connected to the plurality of ONUs 160 via the WDM splitter 140 and the power splitter 150 (in which the former is located upstream of-that is, sequentially closer than-the latter). Each ONU is connected to the power splitter 150 via a dedicated corresponding distribution fibre optic cable 170; that is, a first optic cable 170-1 for ONU 160-1, a second fibre optic cable 170-2 for ONU 160-2, a third fibre optic cable 170-3 for ONU 160-3, and a fourth fibre optic cable 170-4 for ONU 160-4.

The OLT 110 and the OTDR 120 are operatively connected to a higher-layer network management software application (not shown) comprising an Element Management System (not shown) and/or a Network Management System (not shown). For example, via the network management software application, a user or the network 100 may trigger a diagnostic test to be performed by the OTDR 120.

The OTDR 120 is an optical reflectometry measuring device for the network 100. The OTDR 120 enables discovery of physical discontinuities (i.e. breaks in the fibre, faulty connections and splices, excessive fibre bends and other structural deformities) in an optical link.

The OTDR 120 is operated by sending a diagnostics signal down the network 100, this results in backscattering and reflections due to the presence of discontinuities in the fibre structure. By measuring the time that the signal takes to return to the OTDR (from which, distance may be inferred) and the magnitude of the received signal relative to the transmitted signal, a suitably configured OTDR can help determine the location, nature and extent of physical discontinuities. For example, a drop in backscatter to a noise floor may indicate a full break, whereas a small reflection may indicate a connector with an air gap.

In the example of FIG. 1, the OTDR 120 is a standalone device separate to the OLT 110, and the OTDR connects to the plurality of ONUs 160 using, at least, the same portion of the network as the OLT (i.e. via the WDM splitter 140 and power splitter 150).

For later comparison, an exemplary schematic first OTDR test result 180-1, in the form of an OTDR trace, for a first OTDR test performed by the OTDR 120 between the OLT 110 and the first ONU 160-1, is shown in FIG. 1. The OTDR test result 180-1 shows a series of significant (i.e. above a noise floor 195) reflections 185 from Rayleigh backscatter and reflections 187 from relatively high reflective features (e.g. ONUs, connections, etc.) of the fibre optic network. Beyond a certain distance, and at a threshold point 190 (for example, corresponding with the power splitter 150), the reflections 185 from Rayleigh backscatter are attenuated to below a measurement noise floor 195, whereas the reflections 187 from relatively high reflective features remain visible. The reflections 187 exemplarily comprise a first 187-1, second 187-2, third 187-3 and fourth 187-4 peak.

As described in more detail below, the network 100 is manipulated using a Mechanically-Induced Filter (MIF) 200, and changes as a result of the MIF are measured, for example using the OTDR, and processed so as to test characteristics of the network 100.

FIG. 2 is a detailed schematic representation of the Mechanically-Induced Filter (MIF) 200 for use in the network 100.

The MIF 200 comprises a/an: grating 210; primary plate 220; opposing plate 230; first arm 240-1; second arm 240-2; hinge 250; and spring 260.

The grating 210 is a mechanical grating formed of periodic grooves arranged so as to, when forced upon the fibre optic cable 170-1, mechanically induce a loss filter in the form of a Long Period Fibre Grating (LPFG) within the fibre optic cable. For example, the grating is as described in S. Savin, M. J. F. Digonnet, G. S. Kino, and H. J. Shaw, “Tunable mechanically induced long-period fiber gratings” Opt. Lett. 25, 710-712 (2000), the contents of which (herein “Savin et al”) are hereby incorporated by reference.

When pressed against a fibre optic cable, the grating 210 produces periodic pressure points in the fibre optic cable, which, by the photoelastic effect, results in a periodic modulation in refractive index along the fibre optic cable 170-1, thereby creating the LPFG. By varying the periodicity of the induced pressure points, for example by varying the period of the grooves of the grating 210, a filtering wavelength of the LPFG is also variable. Accordingly, the grating is configured and/or operated to induce an LPFG tuned to filter a desired wavelength.

Specifically, to help with network diagnostics without interfering service signals, the periodicity of the grating is set specifically to filter out the wavelength of the diagnostic signal from the OTDR (e.g. between 1600 nm and 1650 nm), whilst also being transparent to wavelengths at which service signals are transmitted and received by the OLT. Alternatively, the periodicity of the grating is set to filter out wavelengths associated with upstream signals from the ONUs 160 (e.g. between 1400 nm and 1600 nm).

The grating 210 is arranged on the primary plate 220 and is exposed. The primary plate 220 is in turn arranged at a terminal end of the first arm 240-1, which is coupled via a hinge 250 to the second arm 240-2 so as to form a handheld hinged tool, and specifically a clamp, tongs, peg or tweezers. The second arm 240-2 comprises an opposing plate 230 for abutting against the grating 210 when the first and second arms are actuated together. The primary plate 220 and the opposing plate 230 are arranged so that, when apart, the fibre optic cable 170-1 is receivable therebetween, and, when actuated together, the fibre optic cable is compressed by the grating 210 and between the primary plate 220 and the opposing plate 230. The spring 260 interconnects the first and second arms so as to urge said arms together, thereby to provide a clamping action. By suitably forcing the grating upon the fibre optic cable 170-1, for example as in the manner described in Savin et al, a LPFG is inducible within the fibre optic cable 170-1.

A jacket or cladding of the fibre optic cable 170-1, or the optical fibre itself, is available to be received and compressed using the MIF 200. In this way, a loss filter can be induced in the fibre optic network, without having to disassemble and then connect such a filter in-line, thereby improving flexibility, ease and continuity of service. In particular, the MIF is available to be applied to a fibre optic cable associated with a distribution network, joint, aggregation node, splitter node, ONU and/or switch.

FIG. 3 shows, schematically, the MIF 200 being used with the network 100, and the filtering effects achieved therefrom.

In the example of FIG. 3, the MIF is used to clamp the fibre optic cable 170-1 at a point downstream of the power splitter 150 and upstream of the first ONU 160-1.

For comparison with the first OTDR test result 180-1, as shown in FIG. 1, FIG. 3 includes an exemplary schematic second OTDR test result 180-2 from a second OTDR test performed by the OTDR 120 towards the first ONU 160-1 and whilst the MIF 200 is used to clamp the first fibre optic cable 170-1 so as to achieve a filtering effect. The second OTDR test result 180-2 also shows a series of significant (i.e. above a noise floor 195) reflections 185 from Rayleigh backscatter and reflections 187 from (corresponding) relatively high reflective features. Beyond a certain distance along the first fibre optic cable 170-1, the peak 187-2 attenuates, and in this example (of high filtering by the MIF 200), collapses to the noise floor 195. In comparison to the first OTDR test result 180-1, the peak 187-2 does not therefore appear; this is consistent with expectations given that the MIF 200 is located downstream of the power splitter 150 and upstream of the ONUs 160, and given also the expected filtering effect of the MIF (i.e. configured to achieve very high filtering at the wavelength of the second OTDR test).

The attenuation of the second peak 187-2 is attributable to the effects of the MIF 200. Since the MIF is physically located upstream of the first ONU 160-1, the peak 187-2 is therefore attributable to the fibre optic cable 170-1 and the first ONU 160-1. Accordingly, it can be concluded that the MIF is clamped to the fibre optic cable 170-1, that the peak 187-2 is associated with the fibre optic cable 170-1, and in turn with the first ONU 160-1.

In some examples, the exact location of the MIF along the fibre optic cable 170-1 can also be determined, where additions of MIF imprints an expected attenuation upon the second OTDR test result 180-2 compared to the first OTDR test result 180-1. In this case, the location of the MIF is available to be marked (or “tagged”) in the OTDR test results 180. In this way, the physical location of the MIF and the location of the MIF in the OTDR test results 180 (as determined by its detected filtering effect) may be reconciled.

FIG. 4 shows an exemplary process 400 for using the MIF 200 to help identify the fibre optic cable 170-1, and specifically to help reconcile a physical fibre optic cable with a fibre optic cable through which a diagnostic test is performed.

At a first step 410, the first OTDR test result 180-1 is retrieved by a computing device (e.g. the OTDR 120, the Element Management System, or a remote computer or mobile device) from a first OTDR test performed by the OTDR 120 without using the MIF 200.

At a next step 420, and in a corresponding manner to the first OTDR test result, the second test result 180-2 is retrieved by the computing device, from a second OTDR test performed by the OTDR 120 whilst the MIF is used to compress the fibre optic cable 170-1. To allow for fair comparison, the first and second OTDR tests are performed using the same wavelength, and the MIF is configured to filter (e.g. maximally) at said wavelength, e.g. 1650 nm.

At a third step 430, the first and second OTDR test results 180 are compared so as to perform a subsequent determination 440 as to whether there is an expected attenuation, attributable to the MIF, in the second OTDR test result 180-2 compared to the first OTDR test result 180-1. The comparison comprises performing signal difference analysis to identify an expected attenuation that corresponds with the estimated, or known, location of the MIF 200 (e.g. upstream of the ONU 160-1, and downstream of the splitter 150) and/or the filtering effect of the MIF (e.g. 90% attenuation at 1650 nm).

All else being equal and functioning as intended, if the expected attenuation is not present in the second OTDR test result, then it is determined that effects of the MIF are not detectable 450, for example because the MIF is beyond range of the OTDR 120 and/or because the fibre optic cable 170-1 onto which the MIF is applied at step 410 does not form a part of the same route through which the OTDR testing is performed at step/s 410 and/or 420.

If, however, the expected attenuation is present 460, then it is determined that the fibre optic cable 170-1 onto which the MIF was applied at step 410 forms a part of the route through which the first and second OTDR tests were performed, and it is determined that the physical location of the MIF 200 corresponds to the second threshold point 190-2, which is marked 470, in association with the MIF, on the first and second OTDR test results 180, and for future corresponding OTDR tests to help map the fibre optic network.

FIG. 5 shows a further process 500, extending from the principles described above, for assisting with physically locating a fault in the network 100 by using the MIF 200 and OTDR testing. Process 500 is described with reference to FIGS. 6a, 6b and 6c, each of which schematically show OTDR test results 600.

In a first step 510, a diagnostic OTDR test is performed through a path that includes the first fibre optic cable 170-1 between the WDM splitter 140 and the power splitter 150, without the MIF 200, yielding a diagnostic OTDR test result 600-1, as shown in FIG. 6a, from which there is identified a fault result 610 (represented as a reflection and a small attenuation) that is indicative of a fault along the fibre optic network (e.g. a faulty connection, a severe bend and/or a broken component). The diagnostic OTDR test is available to correspond with the first OTDR test as per step 410 of process 400.

At a next step 520, the location of the fault result 610 in the diagnostic OTDR test result 600-1 is used to estimate (although, as noted above, typically with some error) the corresponding physical location of the fault in the fibre optic network 100. At, or near, the estimated physical location of the fault, the MIF 200 is then applied to the fibre optic cable between the WDM splitter 140 and the power splitter 150 (identifiable, for example, using process 400). A subsequent OTDR test, configured as per the diagnostic OTDR test in step 520, is then performed whilst compressing the first fibre optic cable 170-1 with the MIF, thereby yielding a subsequent OTDR test result. The second OTDR test is available to correspond with the second OTDR test as per step 420 of process 400.

At a next step 530, the diagnostic and subsequent OTDR test results are compared so as to determine whether the fault result 610 persists (to an extent changed by the filtering effect of the MIF) in the subsequent OTDR test result.

If it is determined that the fault result 610 is present (and unchanged by the filtering effect of the MIF) in both the diagnostic and subsequent OTDR test results, then it is determined that the subsequent OTDR test result was performed with the MIF located downstream of the fault 540; that is, the fault lies between the MIF 200 and the OTDR 120, and that the fault cannot be any more downstream of the MIF 200, thereby setting an ‘upper’ limit to the location of the fault. To illustrate this eventuality, FIG. 6b shows a subsequent OTDR test result 600-2, in which the fault result 610 is still present and unchanged, and in which the MIF is applied at a location 620 downstream of the fault.

If, however, it is determined that the fault result 610 is present only in the diagnostic OTDR test result 600-1, and not in the subsequent OTDR test result of preceding step 520 (or is affected by the filtering effect), then it is determined that the subsequent OTDR test was performed with the MIF 200 located upstream of the fault 550; that is, the fault lies beyond (or away from, or optionally not in-between) both the MIF 200 and the OTDR 120, and that the fault cannot be any more upstream from the MIF, thereby setting a ‘lower’ limit to the location of the fault. To illustrate this eventuality, FIG. 6c shows an alternative subsequent OTDR test result 600-3, in which the fault result is no longer present since the MIF is applied at a location 630 upstream of the fault (and location 620), which therefore prevents the corresponding diagnostics signal from reaching the fault and then producing the fault result.

Regardless of the eventuality, steps 540 and 550 are available to re-iterate to step 520, such that the estimated location of the fault is revised using the range of possible locations (and by estimating distance using time-of-flight information from the OTDR tests) of the fault as constrained by the previously-determined ‘upper’ and/or ‘lower’ limits. In re-iterations of step 520, the MIF 200 is applied at a revised estimated location (i.e. more upstream if step 540 immediately preceded, or more downstream if step 550 immediately preceded), and a further subsequent OTDR test is performed afresh.

In this way, steps 520, 530, 540 and 550 may be re-iterated until the location of the fault is sufficiently constrained. Accordingly, iterative use and adjustment of the MIF, along with OTDR testing, is used to narrow-down, and eventually locate, the fault. For example, using both subsequent OTDR test results 600-2 and 600-3, it is deducible that the fault resides between the physical locations where the MIF was applied when performing each corresponding OTDR test.

Where the location of the MIF 620, as detected on an OTDR test result, is proximate to the fault result 610, then the physical location of the fault 610 is identifiable using conventional ranging based on the OTDR test result, since the error in this distance will have a low absolute value.

FIG. 7 shows a process 700 for identifying a rogue (or a continuous-mode) ONU by using the MIF. A rogue ONU transmits unscheduled (from the perspective of the network operator) signals, which may be due to the rogue ONU being faulty or operating in an unauthorised manner.

In a first step 710, the presence-but not identity-of a rogue ONU within the network 100 is identified; this is performed using techniques known in the art, such as by detecting at the OLT 110 unscheduled upstream optical signals from an ONU. In this example, with reference to FIG. 1, it is identified that-an as-yet unknown-one of the plurality of ONUs 160 is a rogue ONU.

At a next step 720, the MIF 200 is applied to a dedicated fibre optic cable that directly and solely connects a given one of the plurality of ONUs 160 to the splitter 150. For example, in a first iteration of step 720 the MIF is applied to the first fibre optic cable 170-1 (i.e. uniquely connecting the first ONU 160-1), thereby to induce a filtering effect upon transmissions through said fibre optic cable. Since, rogue ONUs are typically characterised by their upstream transmissions, the MIF is tuned (by selecting the appropriate grating periodicity) to significantly attenuate a wavelength of upstream transmissions from ONUs (e.g. between 1300 nm and 1550 nm), for example as detected by the OLT.

At a next step 730, at the OLT 110, detection of the effects of the rogue ONU are reassessed whilst the MIF remains applied to the selected fibre optic cable, for example using the same technique used to detect the presence of a rogue ONU as used at step 710.

Following step 730, if, as per eventuality 740, it is determined that the effects of the rogue ONU persist whilst the MIF remains applied to the selected fibre optic cable 170-1, and that the detected effects of the rogue ONU are not attenuated in a manner and/or to an extent expected of the filtering effects of the MIF (e.g. complete attenuation), then it is concluded that the ONU uniquely associated with fibre optic cable to which the MIF was applied in preceding step 720 is not the rogue ONU, and is marked as such and as having already been tested.

Following step 740, process 700 re-iterates to step 720, at which point the MIF is subsequently applied to a dedicated fibre optic cable, different to that to which the MIF was applied at any preceding step 720, that directly and solely connects another one of the plurality of ONUs 160 to the splitter 150. For example, in a second iteration of step 720 the MIF is applied to the second fibre optic cable 170-2 (i.e. uniquely connecting the second ONU 160-2), thereby to induce a filtering effect upon transmissions through said fibre optic cable.

Cycling of steps 720, 730 and 740 is available to be performed until no rogue ONU is identified (in which case, it may be concluded that there is no rogue ONU, and that there is another kind of fault) or until the identity of the rogue ONU is determined, as per eventuality 750.

At step 750, if it is determined that the effects of the rogue ONU no longer persist whilst the MIF remains applied to the fibre optic cable selected in immediately preceding step 720, for example by attenuating in a manner and/or to an extent expected of the filtering effects of the MIF, then it is concluded that the ONU uniquely associated with this fibre optic cable is the rogue ONU. Remedial action may subsequently be taken, including repairing or disconnecting the identified rogue ONU, and/or leaving the MIF applied to the fibre optic cable associated with the identified rogue ONU, thereby to filter out the effects of the rogue ONU.

### Alternatives and Modifications

With reference to process 400, in an alternative, step 420 precedes step 410, such that an OTDR test with the use of the MIF is performed before a corresponding test without the MIF.

It will be appreciated that for processes 400, 500 and 700, the MIF 200 is used merely to induce a detectable relative-rather than absolute-change in transmissivity. Accordingly, whilst greater filtering effects of the MIF are desirable, the MIF is configured to cause any detectable extent of filtering.

Furthermore, the MIF 200 and/or the OTDR 120 is available to be operated in ways so as to change the filtering effect so as to allow for relative comparison. For example, the extent of the filtering effect of the MIF is dependent upon the:
force with which the MIF is applied upon the fibre optic cable, such that increasing the force with which the MIF is clamped against the fibre optic cable increases the filtering effect;
the angle of the grating relative to the fibre optic cable, thereby changing the effective period of the LPFG induced within the fibre optic cable, and therefore tuning the filtering effect of the MIF;
the length of the grating (including using multiples MIFs), such that increasing the length of the grating (whilst keeping periodicity constant) effectively induces a longer LPFG, and in turn increases the filtering effect; and
the wavelength of light transmitted through the fibre optic cable, thereby to allow light transmissions to be brought in- or out-of-band of the wavelength to which the MIF is tuned to filter.

Furthermore, in an alternative, with reference to process 400, rather than adding and removing the MIF from a fibre optic cable, the MIF is available to remain continuously clamped to a fibre optic cable, and a wavelength of the optical test signal is available instead to be varied across each OTDR test. In one optical test signal (e.g. the first), a first wavelength is selected that achieves low filtering, whereas in another optical test signal (e.g. the second), a second wavelength is selected that achieves a relatively higher degree of filtering. Correspondingly, the same principle can be extended to processes 500 and 700.

As a consequence, the MIF 200 can remain in situ clamped to the fibre optic cable, with force, angle, length or wavelength varied so as to render the MIF transparent or opaque. In this way, service signals can effectively continue to be communicated whilst the MIF remains in situ but tuned to be transparent to the wavelength of the service signals.

In an alternative, with reference to process 500, after step 540, rather than moving the existing MIF 200, a new MIF can be added to the fibre optic network at step 520. Where the MIF and the new MIF are configured to achieve different extents of filtering at different wavelengths, as described above, across multiple iterations of step 530, the subsequent OTDR tests can be performed by selectively using different wavelengths based on the wavelength to which each MIF is specifically tuned to filter. For example, after step 550, a wavelength to which a more upstream MIF is transparent, but to which a more downstream MIF is opaque, is used at subsequent step 520, thereby to prevent filtering by the upstream MIF, which would otherwise conceal the fault and the more downstream MIF.

Although process 500 is primarily described with reference to identifying a fault, it will be appreciated that process 500 can be extended to locating any feature of the fibre optic network that is detectable by an optical reflectometry measuring device, such as an arbitrary selected location, component or joint, whether impaired or fully functioning.

As described above, process 700 is performed individually to eliminate ONUs as the rogue ONU. However, process 700 may be adapted such that the MIF is applied to a fibre optic cable connecting a plurality-but not all of the plurality-of ONUs 160 (i.e. a subset), thereby to eliminate multiple ONUs at a time, including at a point upstream of the splitter 120, where multiple such splitters are provided within the network 100.

It will be appreciated that the MIF 200 shown in, and described with reference to, FIG. 2 is merely exemplary and that other forms of MIFs are available to be used that need only mechanically-induce a loss filter in a fibre optic cable.

Each feature disclosed herein, and (where appropriate) as part of the claims and drawings may be provided independently or in any appropriate combination.

Any reference numerals appearing in the claims are for illustration only and shall not limit the scope of the claims.

1. A method of testing a fibre optic network so as to locate a feature of said network using a Mechanically Induced Filter, MIF, comprising a grating, the method comprising the steps of:
retrieving, from an optical reflectometry measuring device, a:
first test result, from a first optical reflectometry test performed through a fibre optic cable of the fibre optic network, said first test result comprising a reflection result indicative of a feature within the fibre optic network;
second test result, from a second optical reflectometry test performed whilst using a MIF to force the grating upon the fibre optic cable, at a selected location, so as to cause a filtering effect upon the second test result;
comparing the first test result and the second test result so as to identify whether the reflection result is affected in the second test result by the filtering effect; and
determining, along the fibre optic cable, a location range for the feature, in which said location range is determined to be:
away from both the optical reflectometry measuring device and the selected location, in response to identifying that the reflection result is affected by the filtering effect; and
between the optical reflectometry measuring device and the selected location, in response to identifying that the reflection result is not affected by the filtering effect.

2. A method according to claim 1, further comprising the step of:
applying the, or another, MIF at a subsequently selected location, wherein said subsequently selected location is within the location range;
retrieving, from the optical reflectometry measuring device, a third test result, from a third optical reflectometry test performed whilst using said MIF to force the grating upon the fibre optic cable, at the subsequently selected location, so as to result in the filtering effect upon the third optical reflectometry test;
comparing the first test result, or the second test result, and the third test result so as to identify whether the reflection result is affected in the second test result by the filtering effect; and
determining a further location range for the feature, in which said further location range is determined to be:
away from both the optical reflectometry measuring device and the subsequently selected location, in response to identifying that the reflection result is affected by the filtering effect; and
between the optical reflectometry measuring device and the subsequently selected location, in response to identifying that the reflection result is not affected by the filtering effect.

3. A method according to claim 1, wherein the first test is also performed whilst compressing the grating upon the fibre optic cable, and is performed so as to cause a lesser filtering effect upon the first optical reflectometry test compared to the filtering effect upon the second and/or third optical reflectometry test/s.

4. A method according to claim 3, wherein the lesser filtering effect is achieved by performing the first optical reflectometry test using a different wavelength to a wavelength used for the second optical reflectometry test, wherein the MIF is configured to cause the lesser filtering effect at said different wavelength, but not at the wavelength.

5. A method according to claim 3, wherein the lesser filtering effect is achieved by performing the first optical reflectometry test whilst compressing the grating upon the fibre optic cable with a lesser force than when performing the second optical reflectometry test.

6. A method according to claim 1, wherein the first test is performed without compressing the grating upon the fibre optic cable.

7. A method according to claim 1, wherein the MIF is configured to induce a Long-Period Fiber Grating, LPFG, when compressing the grating upon the fibre optic cable.

8. A method according to claim 1, wherein the grating is directly urged upon a jacket or a cladding of the fibre optic cable.

9. A method according to claim 1, wherein the optical reflectometry measuring device is an Optical Time-Domain Reflectometer, OTDR, and/or an Optical Line Terminal for transmitting and receiving a telecommunications service signal through the fibre optic network.

10. A method according to claim 1, wherein the first and/or second optical reflectometry test/s is/are performed using a service signal and/or a diagnostic test signal.

11. A method according to claim 1, wherein the MIF is remotely operated so as to be urged against the fibre optic cable, thereby to cause the first and/or second extents of filtering.

12. A computer-readable carrier medium comprising a computer program, which, when the computer program is executed by a computer, causes the computer to carry out the steps of any claim 1.

13. A system for testing a fibre optic network so as to locate a feature of said network, said system comprising a:
Mechanically Induced Filter, MIF, comprising a grating configured to be forced upon the fibre optic cable; and
processor configured to:
retrieve, from an optical reflectometry measuring device, a:
first test result, from a first optical reflectometry test performed through a fibre optic cable of the fibre optic network, said first test result comprising a reflection result indicative of a feature within the fibre optic network;
second test result, from a second optical reflectometry test performed whilst using a MIF to force the grating upon the fibre optic cable, at a selected location, so as to cause a filtering effect upon the second test result;
compare the first test result and the second test result so as to identify whether the reflection result is affected in the second test result by the filtering effect; and
determine, along the fibre optic cable, a location range for the feature, in which said location range is determined to be:
away from both the optical reflectometry measuring device and the selected location, in response to identifying that the reflection result is affected by the filtering effect; and
between the optical reflectometry measuring device and the selected location, in response to identifying that the reflection result is not affected by the filtering effect.
